(19) United States
(12) Patent Application Publication
(10) Pub. No.: US 2008/0083573 A1
(43) Pub. Date: Apr. 10, 2008

(54) Vehicle

(75) Inventor: Chih-Hung Tseng, Taichung (TW)

Correspondence Address: QUINE INTELLECTUAL PROPERTY LAW GROUP, P.C., P O BOX 458, ALAMEDA, CA, 94501, US

(73) Assignee: P&F Brother Industrial Corporation, Taichung (TW)

(21) Appl. No.: 11/543,344

(22) Filed: Oct. 4, 2006

(51) Int. Cl. B60K 1/00; B60G 21/05; B62D 49/08

(52) U.S. Cl. 180/65.1; 280/755; 180/907; 280/124.128

(57) ABSTRACT

A vehicle includes: a chassis; a driving unit including a mounting seat pivoted to the chassis, a driving member mounted on the mounting seat, and two driving wheels mounted rotatably on the mounting seat and driven by the driving member; two front wheel units, each including a front lever having first and second ends and pivoted to the chassis, a front wheeled member connected to the first end, and a first cushioning member pivoted to the second end and the mounting seat for urging the front lever to rotate; and two rear wheel units, each including a rear lever having first and second ends and pivoted to the chassis, a rear wheeled member connected to the first end, a second cushioning member pivoted to the first end and the mounting seat, and a linkage pivoted to the second end of the rear lever and the mounting seat.

### BACKGROUND OF THE INVENTION

1. Field of the Invention

The invention relates to a vehicle, more particularly to a vehicle having a transmission mechanism for moving the vehicle on an uneven ground more smoothly and stably.

2. Description of the Related Art

Referring to FIG. 1, a conventional vehicle 10 has a chassis 11 having two opposite sides, a driving unit 12 mounted at a middle position of the chassis 11, a pair of front wheel units 13 disposed respectively at the two opposite sides of the chassis 11, and a pair of rear wheel units 14 disposed respectively at the two opposite sides of the chassis 11. The driving unit 12 uses a motor (not shown) to drive the vehicle 10. Each of the front wheel units 13 includes a front pivot seat 131, a front wheel frame 132 connected pivotably to the front pivot seat 131, a front wheel 133 mounted on the front wheel frame 132, and a resilient member 134 interconnecting the front wheel frame 132 and the chassis 11. Each of the rear wheel units 14 includes a rear wheel frame 141 connected pivotably to a rear of the chassis 11, a rear wheel 142 mounted on the rear wheel frame 141, and a cushioning member 143 interconnecting the rear wheel frame 141 and the chassis 11. Through pivoting movements of the front and rear wheel frames 132, 141 and cushioning functions of the resilient members 134 and the cushioning members 143, the vehicle 10 can move on an uneven ground and provide a shock absorbing effect.

However, since there is no connection between the driving unit 12 and the front wheel units 13 or the rear wheel units 14, the driving unit 12 is undesirably lifted from the ground when either the front wheel units 13 or the rear wheel units 14 encounter a bump on an uneven ground, thereby resulting in an adverse affect on the movement of the vehicle 10.

### SUMMARY OF THE INVENTION

Therefore, the object of the present invention is to provide a vehicle that can overcome the aforesaid drawback associated with the prior art.

Accordingly, a vehicle of the present invention comprises: a chassis having two opposite sides; a driving unit including a mounting seat that is pivoted to the chassis, a driving member that is mounted on the mounting seat, and a pair of driving wheels that are mounted rotatably on the mounting seat, that are disposed respectively at the two opposite sides of the chassis, and that are driven by the driving member, the driving wheels being rotatable about a central axis; a pair of front wheel units disposed respectively at the two opposite sides of the chassis, each of the front wheel units including a front lever that has first and second ends and that is pivoted to the chassis about a first axis between the first and second ends of the front lever, a front wheeled member that is connected to the first end of the front lever, and a first cushioning member that is pivoted to the second end of the front lever and the mounting seat for urging the front lever to rotate about the first axis in a first rotation direction, the first axis being disposed frontwardly of the central axis; and a pair of rear wheel units disposed respectively at the two opposite sides of the chassis. Each of the rear wheel units includes a rear lever that has first and second ends and that is pivoted to the chassis about a second axis between the first and second ends of the rear lever, a rear wheeled member that is connected to the first end of the rear lever, a second cushioning member that is pivoted to the first end of the rear lever and the mounting seat for urging the rear lever to rotate about the second axis in a second rotation direction opposite to the first rotation direction, and a linkage that is pivoted to the second end of the rear lever and the mounting seat. The second axis is disposed rearwardly of the central axis.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled schematic view of a conventional vehicle;

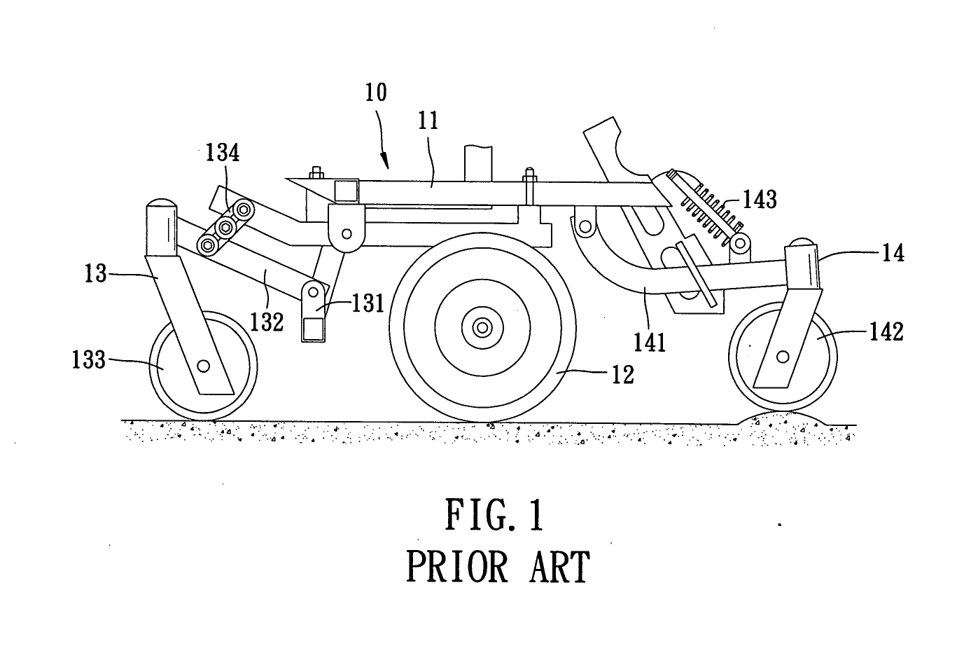

FIG. 2 is an assembled perspective view of the preferred embodiment of a vehicle according to the present invention;

FIG. 3 is a schematic view of the preferred embodiment;

FIG. 4 is a schematic view of the preferred embodiment to illustrate connection between a transmission mechanism and a front wheel unit or a rear wheel unit of the preferred embodiment;

FIG. 5 is a schematic view of the preferred embodiment to illustrate a state where a driving unit is passing over a bump on the ground; and

FIG. 6 is a schematic view of the preferred embodiment to illustrate another state where the driving unit is passing along a depressed ground surface.

### DETAILED DESCRIPTION OF THE PREFERRED EMBODIMENT

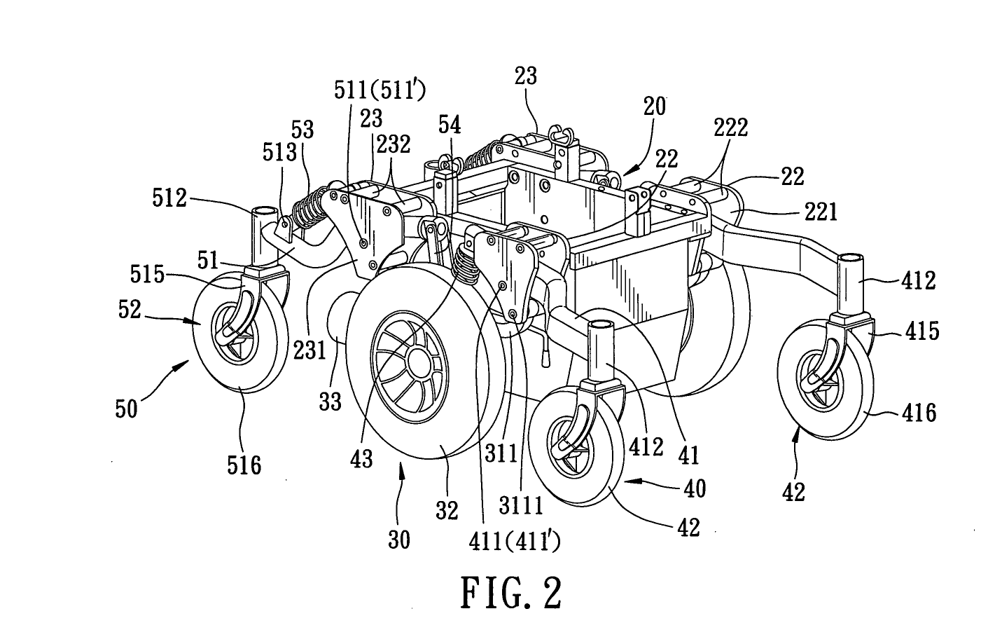

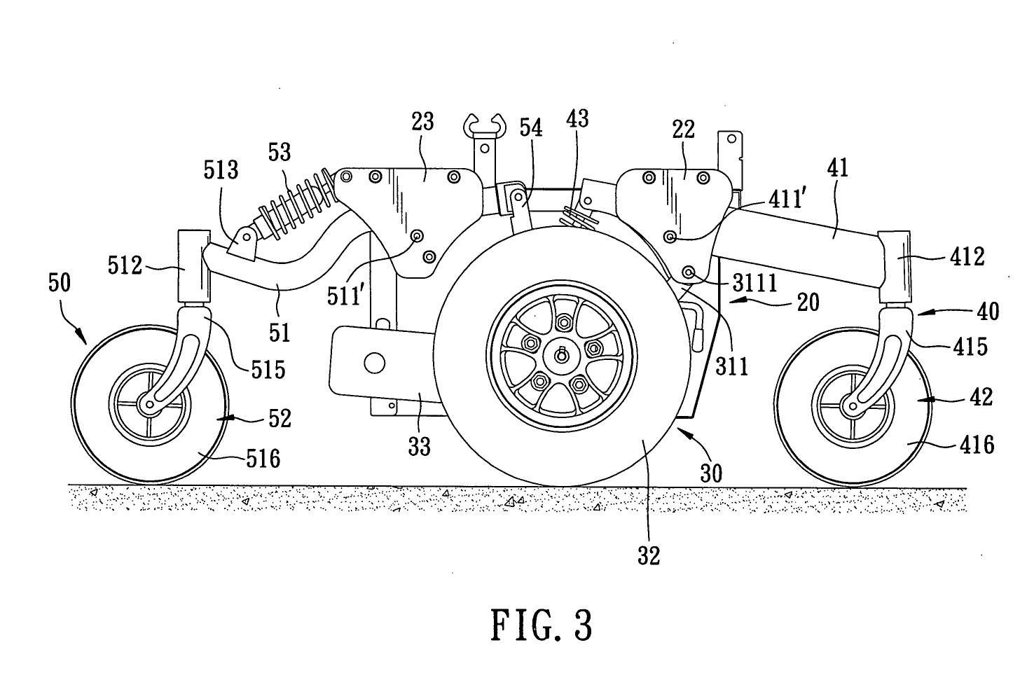

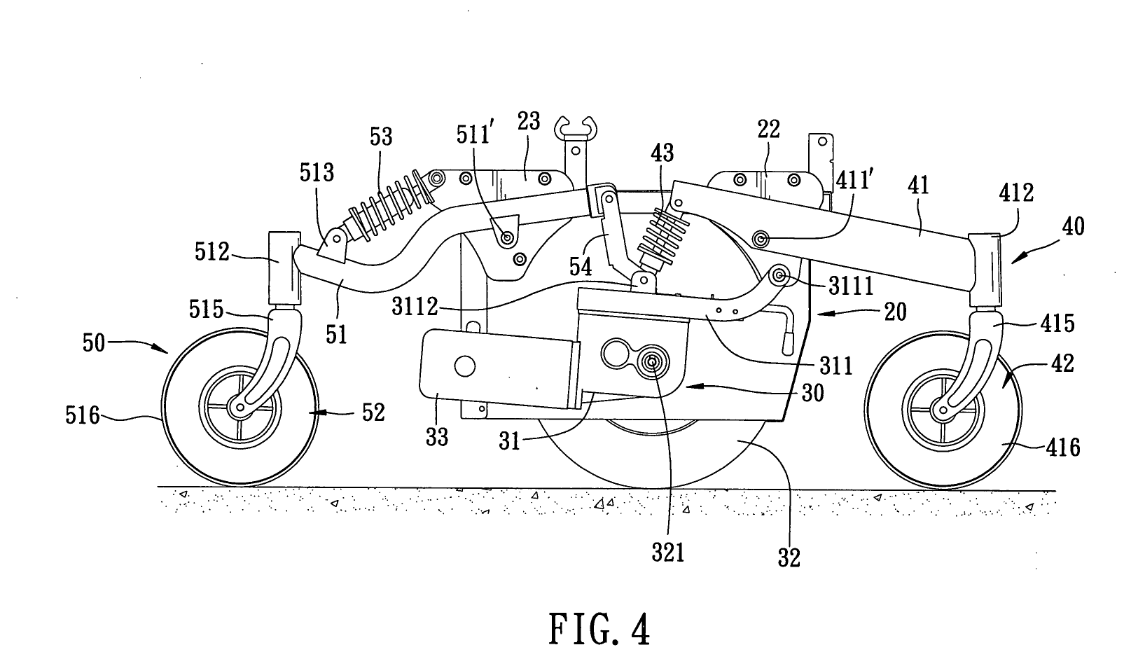

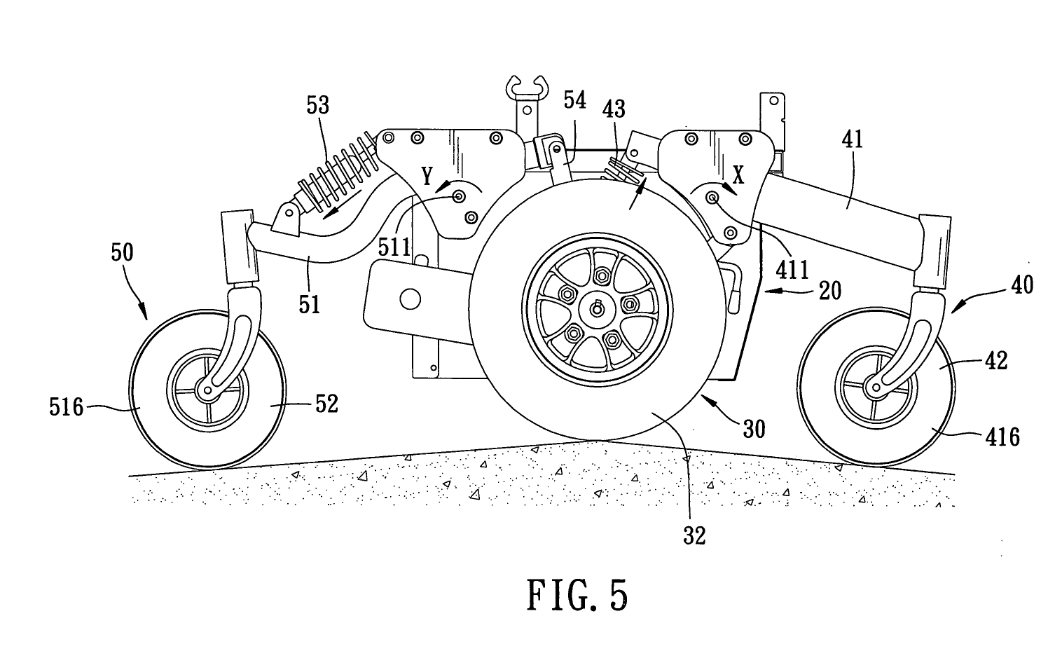

Referring to FIGS. 2 to 4, the preferred embodiment of a vehicle according to the present invention is shown to include: a chassis 20 having two opposite sides; a driving unit 30 including a mounting seat 31 that is pivoted to the chassis 20, a driving member 33 that is mounted on the mounting seat 31, and a pair of driving wheels 32 that are mounted rotatably on the mounting seat 31, that are disposed respectively at the two opposite sides of the chassis 20, and that are driven by the driving member 33, the driving wheels 32 being rotatable about a central axis 321; a pair of front wheel units 40 disposed respectively at the two opposite sides of the chassis 20, each of the front wheel units 40 including a front lever 41 that has first and second ends and that is pivoted to the chassis 20 about a first axis 411 between the first and second ends of the front lever 41, a front wheeled member 42 that is connected to the first end of the front lever 41, and a first cushioning member 43 that is pivoted to the second end of the front lever 41 and the mounting seat 31 for urging the front lever 41 to rotate about the first axis 411 in a first rotation direction (X) (see FIG. 5), the first axis 411 being disposed frontwardly of the central axis 321; and a pair of rear wheel units 50 disposed respectively at the two opposite sides of the chassis 20, each of the rear wheel units 50 including a rear lever 51 that has first and second ends and that is pivoted to the chassis 20 about a second axis 511 between the first and second ends of the rear lever 51, a rear wheeled member 52 that is connected to the first end of the rear lever 51, a second cushioning member 53 that is pivoted to the first end of the rear lever 51 and the mounting seat 31 for urging the rear lever 51 to rotate about the second axis 511 in a second rotation direction (Y) (see FIG. 5) opposite to the first rotation direction (X), and a linkage 54 that is pivoted to the second end of the rear lever 51 and the mounting seat 31, the second axis 511 being disposed rearwardly of the central axis 321.

In this embodiment, the mounting seat 31 of the driving unit 30 is provided with a pair of linking arms 311 disposed respectively at the two opposite sides of the chassis 20. Each of the linking arms 311 is pivoted to the chassis 20 about a fourth axis 3111, and has a pivot protrusion 3112 protruding therefrom. The first cushioning member 43 of each of the front wheel units 40 is pivoted to the pivot protrusion 3112 of a respective one of the linking arms 311, and the linkage 54 of each of the rear wheel units 50 is pivoted to the pivot protrusion 3112 of a respective one of the linking arms 311. The front and rear levers 41, 51, the front and rear cushioning members 43, 53, and the linkage 54 constitute a transmission of the vehicle that transmits mechanical power to the front and rear wheeled members 42, 52.

The chassis 20 is provided with a pair of front pivot seats 22 that are disposed respectively at the two opposite sides of the chassis 20, a pair of rear pivot seats 23 that are disposed respectively at the two opposite sides of the chassis 20, a pair of front pivot pins 411′, and a pair of rear pivot pins 511′. Each of the front pivot seats 22 includes a pair of interconnected pivot plates 221 that cooperatively define a front receiving space therebetween, and each of the rear pivot seats 23 includes a pair of interconnected pivot plates 231 that cooperatively define a rear receiving space therebetween. Each of the front pivot pins 411′ interconnects the pivot plates 221 of a respective one of the front pivot seats 22, and each of the rear pivot pins 511′ interconnects the pivot plates 231 of a respective one of the rear pivot seats 23. The front lever 41 of each of the front wheel units 40 extends into and through the front receiving space in a respective one of the front pivot seats 22, and is pivoted to a respective one of the front pivot pins 411′. The rear lever 51 of each of the rear wheel units 50 extends into and through the rear receiving space in a respective one of the rear pivot seats 23, and is pivoted to a respective one of the rear pivot pins 511′. In this embodiment, the chassis 20 is further provided with front connecting pins 222, and rear connecting pins 232. The front connecting pins 222 interconnect the pivot plates 221 of a respective one of the front pivot seats 22, and the rear connecting pins 232 interconnect the pivot plates 231 of a respective one of the rear pivot seats 23.

In this embodiment, the driving member 33 is in the form of a motor for driving rotation of the driving wheels 32. A speed reduction mechanism (not shown) is mounted in the mounting seat 31 of the driving unit 30 and is connected to the motor for rotating the driving wheels 32 on the ground. The driving wheels 32 are mounted on an axle that is mounted on the mounting seat 31 and that defines the central axis 321.

The rear lever 51 of each of the rear wheel units 50 is provided with a pivot protrusion 513. The second cushioning member 53 is pivoted to the pivot protrusion 513. Each of the first and second cushioning members 43, 53 is in the form of a spring-biased shock absorber.

Each of the front and rear wheeled members 42, 52 includes a down tube 412, 512, a fork 415, 515 extending from the down tube 412, 512, and a wheel 416, 516 mounted rotatably on the fork 415, 515. The first end of the front lever 41 is secured to the down tube 412 of the front wheeled member 42, and the first end of the rear lever 51 is secured to the down tube 512 of the rear wheeled member 52.

In operation, referring to FIG. 5, when the driving wheels 32 are moved to a highest point of an uneven ground, the first cushioning members 43 urge the front levers 41 to rotate about the first axis 411 in the first rotation direction (X) so that the front wheels 416 are moved downward to abut against the ground. In a like manner, the second cushioning members 53 urge the rear levers 51 to rotate about the second axis 511 in the second rotation direction (Y) so that the rear wheels 516 are moved downward to abut against the ground. As such, the front wheels 416, the rear wheels 516 and the driving wheels 32 are all brought to abut against the ground stably and simultaneously.

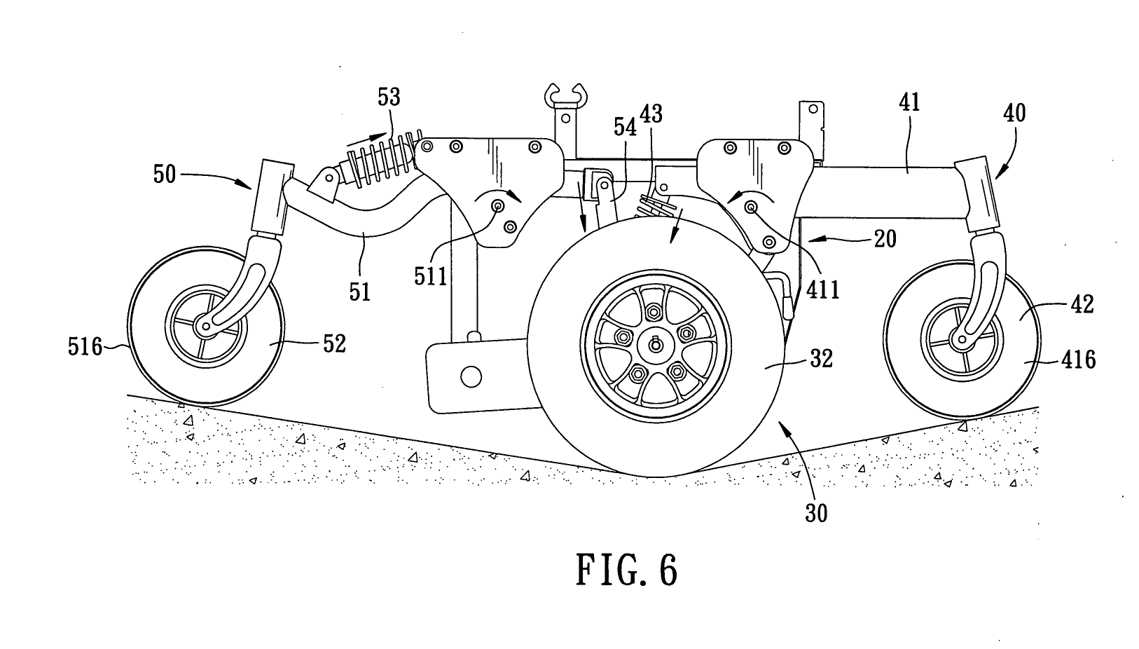

Referring to FIG. 6, when the driving wheels 32 are moved to a lowest point on an uneven ground, the front and rear levers 41, 52 are pushed respectively by the front and rear wheels 416, 516 to rotate respectively about the first and second axes 411, 511 in the second and first rotation directions (Y, X) so that the driving wheels 32 are pressed downward to abut stably against the ground.

With the inclusion of the transmission mechanism in the vehicle of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A vehicle comprising:
a chassis having two opposite sides;
a driving unit including a mounting seat that is pivoted to said chassis, a driving member that is mounted on said mounting seat, and a pair of driving wheels that are mounted rotatably on said mounting seat, that are disposed respectively at said two opposite sides of said chassis, and that are driven by said driving member, said driving wheels being rotatable about a central axis;
a pair of front wheel units disposed respectively at said two opposite sides of said chassis, each of said front wheel units including a front lever that has first and second ends and that is pivoted to said chassis about a first axis between said first and second ends of said front lever, a front wheeled member that is connected to said first end of said front lever, and a first cushioning member that is pivoted to said second end of said front lever and said mounting seat for urging said front lever to rotate about said first axis in a first rotation direction, said first axis being disposed frontwardly of said central axis; and
a pair of rear wheel units disposed respectively at said two opposite sides of said chassis, each of said rear wheel units including a rear lever that has first and second ends and that is pivoted to said chassis about a second axis between said first and second ends of said rear lever, a rear wheeled member that is connected to said first end of said rear lever, a second cushioning member that is pivoted to said first end of said rear lever and said mounting seat for urging said rear lever to rotate about said second axis in a second rotation direction opposite to said first rotation direction, and a linkage that is pivoted to said second end of said rear lever and said mounting seat, said second axis being disposed rearwardly of said central axis.

2. The vehicle as claimed in claim 1, wherein said mounting seat of said driving unit is provided with a pair of linking arms disposed respectively at said two opposite sides of said chassis, each of said linking arms being pivoted to said chassis, and having a pivot protrusion protruding therefrom, said first cushioning member of each of said front wheel units being pivoted to said pivot protrusion of a respective one of said linking arms, said linkage of each of said rear wheel units being pivoted to said pivot protrusion of a respective one of said linking arms.

3. The vehicle as claimed in claim 2, wherein said chassis is provided with a pair of front pivot seats that are disposed respectively at said two opposite sides of said chassis, a pair of rear pivot seats that are disposed respectively at said two opposite sides of said chassis, a pair of front pivot pins, and a pair of rear pivot pins, each of said front pivot seats including a pair of interconnected pivot plates that cooperatively define a front receiving space therebetween, each of said rear pivot seats including a pair of interconnected pivot plates that cooperatively define a rear receiving space therebetween, each of said front pivot pins interconnecting said pivot plates of a respective one of said front pivot seats, each of said rear pivot pins interconnecting said pivot plates of a respective one of said rear pivot seats, said front lever of each of said front wheel units extending into and through said front receiving space in a respective one of said front pivot seats and being pivoted to a respective one of said front pivot pins, said rear lever of each of said rear wheel units extending into and through said rear receiving space in a respective one of said rear pivot seats and being pivoted to a respective one of said rear pivot pins.

4. The vehicle as claimed in claim 1, wherein said driving member is in the form of a motor for driving rotation of said driving wheels.

5. The vehicle as claimed in claim 1, wherein each of said first and second cushioning members is in the form of a spring-biased shock absorber.

6. The vehicle as claimed in claim 1, wherein each of said front and rear wheeled members includes a down tube, a fork extending from said down tube, and a wheel mounted rotatably on said fork, said first end of said front lever being secured to said down tube of said front wheeled member, said first end of said rear lever being secured to said down tube of said rear wheeled member.
